(19) United States
(12) Patent Application Publication
(10) Pub. No.: US 2008/0172579 A1
(43) Pub. Date: Jul. 17, 2008

(54) Test Device For Verifying A Batch Processing

(76) Inventors: Uwe Hahm, Unterschleissheim (DE); Roland Griessbach, Lehrte (DE)

Correspondence Address: FRASER CLEMENS MARTIN & MILLER LLC, 28366 KENSINGTON LANE, PERRYSBURG, OH, 43551, US

(21) Appl. No.: 11/908,186

(22) PCT Filed: Mar. 10, 2006
(86) PCT No.: PCT/EP2006/002238

§ 371 Date: Sep. 10, 2007

(30) Foreign Application Priority Data
Mar. 10, 2005 (EP) 05005288.5

(51) Int. Cl. G06F 11/36; G06F 11/28

(52) U.S. Cl. 714/37; 714/38; 714/E11.178

(57) ABSTRACT

The invention relates to a test device (1) and associated method for verifying a batch processing in a data processing device (2) comprising a first scheduling device (3) for controlling a data processing which processes the script library (5) scripts by means of a first script interface (4), thereby carrying out or controlling the operation of a company subordinate devices. The aim of said invention is to verify a batch processing without degrading a verifiable system performance. For this purpose, a second scheduling device (7) for simulating the processing of the script library (5) scripts and for transmitting said scripts to the device (1) for testing data resulting from the simulation by a second script interface (8) dependent of the first scheduling device (3) is added.

The invention relates to a test device as well as a test method for verifying batch processing according to the preambles of claim 1 or claim 10, respectively.

In most, chiefly large businesses, typically commonly used computer resources are not made directly available, but the tasks to be processed are collected and processed according to certain time or priority criteria. Then the tasks to be processed—hereinafter jobs—are collected and processed in a stack or batch processing step in the sequence to be ascertained by the criteria mentioned.

The Job Control Language (JCL) is a known control language for batch processing in a mainframe computer environment. It was developed originally as early as 1964 for the MVS operating system, later developed into OS/360 and is still used today in systems under z/OS. Accordingly in the IBM mainframe world, the typical job or script language is JCL. In the peripheral system environment (Windows, Unix, Linux) a wide variety of script languages is used.

The following short code snippet illustrates a program launch in JCL:

//JOB 1 JOB (12345), MSGCLASS=X
//STEP1 EXEC PGM=XYZ, PARM= (A1, B2, C3)
//DD1 DD DSN=AB.CD.EFGH, DISP=(OLD, DELETE)

Here parameters A1, B2 and C3 are transferred to program XYZ during launch. The program XYZ uses the existing (“OLD”) data base AB.CD.EFGH and deletes it (“DELETE”) after the program end.

So as to process the batch jobs in the desired sequence, the system must of course be in a position to plan and control the batch processing operation. The system responsible for this is called the scheduling system. The goal of this system is to automate the planning, execution and control of the entire batch production in a computing center under consideration and the most optimal utilization possible of the available resources. A scheduling system plans and controls many thousand processes, scripts, or jobs in a computing center.

The jobs are processed in a certain order in a scheduling system as a function of dependencies, which is to say started and checked for their successful execution. Jobs are frequently dependent upon one another, for example, Job B must not start until the end of Job A. Moreover there are still further dependency types, such as starting time, resource control or condition code control.

An entry in an operating system table is necessary to start some scheduling systems. Operating system tables, into which subsystem names are entered, among other things, are organized at the system level.

Some scheduling systems can only be started as started task. An entry in a started task table is necessary for this. A started task corresponds to a system procedure which is started and remains active as long as no stop command is issued. Started task tabless are organized at the system level.

As a rule, appropriate authorizations are needed to start/stop a started task, for the operation and for the set-up/creation of files as well as for executing functions within scheduling system which are filed in the security system (for example, RACF).

Examples of known scheduling systems are the Tivoli Workload Scheduler (TWS) by IBM, [blank]-7 from CA or CONTROL-M from BMC. JCL can be variably used for cooperation with scheduling systems, since it also knows scheduling variables, which can be resolved or replaced by the scheduling system prior to starting a job, in addition to JCL procedure variables, which can be used in using JCL procedures. This should once again be explained on the basis of the modified code snipped from above:

//JOB 1 JOB (12345), MSGCLASS=X
//STEP1 EXEC PGM=XYZ, PARM= (A1, B2, C3)
//DD1 DD DSN=D&HLQDATE . . CD.EFGH,
DISP=(OLD, DELETE)

The &HLQDATE string is such a scheduling variable. The scheduling system knows the value of the scheduling variable and replaces the &HLQDATE string, in this case perhaps by the current date. The result would then be, after resolution of &HLQDATE, on Feb. 28, 2005:

//JOB 1 JOB (12345), MSGCLASS=X
//STEP1 EXEC PGM=XYZ, PAAM= (A1, B2, C3)
//DD1 DD DSN=AB.D050228.CD.EFGH, DISP=(OLD, DELETE)

The JCL is usually filed in its own job libraries or JCL libraries. The scheduling system reads these JCL libraries at the start of a job.

The correct sequence for batch processing is extremely important for every operation since a standstill in production could occur in the worst case in the event of errors. In order to rule out or at least diminish this danger, it is possible to verify the jobs before their “real” use. A program which accomplishes this is referred to as a JCL checker. Primarily, the correct notation is verified in this connection, thus a syntax check is performed. Above and beyond this, some JCL checkers can also perform additional tests, perhaps whether the program to be called up exists at all, whether the necessary files are available, whether the control card directions or the program parameters are correct.

Some scheduling systems have an internal simulation function with which JCL scripts can be simulated for supporting such verification. The simulation function then usually provides an official interface for external programs. Here the external program can communicate to the scheduling system for which job should be simulated at which execution time, and the result that is returned is the resolved JCL.

A scheduling system (sometimes also several scheduling systems) is/are in use in the production or productive system. This is referred to as the productive scheduling system. Often independent scheduling systems are used on the test and/or development systems, which are then correspondingly referred to as test scheduling systems.

Each scheduling system must be independently installed and implemented. As a rule, many files are created, which are needed to operate the scheduling system. Specific running data can be sent along to the scheduling system using parameter files.

All attributes to a job are stored in independent definition files in a scheduling system. As a rule the scheduling systems have an additional file/data base in which all jobs to be implemented or which have been implemented are listed. This file is often referred to as the daily schedule or active file. A scheduling system uses its own sequences for generating the daily schedule from the data of the definition files. Frequently, these are also jobs which can be generated by the scheduling system itself or dynamically by the user.

Just to provide a measure of the scope that a scheduling system must be able to handle, it should be stated that in a productive scheduling system of a large computing center, between 50,000 and 100,000 jobs are executed a day, whereby of course many millions of files must be processed.

The following exemplary scenario describes the sequence for the TWS s/OZ (formerly OPC) scheduling system.

TWS possesses an internal JCL simulation function by the name of JCLPREPA. Individual jobs can be simulated with this simulation function. The SmartJCL JCL Checker marketed by the applicant HORIZONT uses this JCL simulation function to simulate individual jobs, for example, in a user dialog. The HORIZONT JCL Checker can nonetheless also be used to simulate many jobs (=mass simulation).

Nevertheless a massive performance problem arises in connection with conventional mass simulation. Users wishing to access the job libraries during a simulation run, for example to maintain the JCL scripts via the dialog of TWS z/OZ, are pushed into the background and must wait a long time for access to the JCL or else in some situations will not even be able to access it. Since a mass simulation run, in which the JCL simulation function is called up for a plurality of jobs one after the other, can last several hours, this leads to an impairment of the users, which is not tolerable. Another significant aspect is that the TWS z/OZ scheduling system itself is also slowed down during JCL access and correspondingly issues error messages. A negative influence on the productive scheduling system of this type can become extremely dangerous for production and must therefore be prevented.

It is thus the object of the invention to enable a verification of batch processing which does not impair the performance of the verified system.

This object is achieved by a test device in accordance with claim 1 as well as by a testing method in accordance with claim 10. Moreover, the productive scheduling system can be relieved by the use of a second scheduler so that it does not suffer any loss in performance through mass simulation.

In order to discover this solution, the inventors first had to find out at which location the performance slump is chiefly caused. They came to the conclusion that at least the TWS z/OS scheduling system has an internal bottleneck when accessing the job libraries, which affects the scheduling system itself, but also the user. Based on this finding, the inventors were guided by the idea of expanding the capacity of this library access. They recognized that an expansion of the interface between TWS z/OS and the job library was a possibility which they could implement in a particularly elegant and simple manner by using a further scheduling system with its own, accordingly independent interface.

Advantageously the second scheduler with its second script interface is a part of the data processing facility. Consequently no additional hardware is needed and the test is especially realistic.

Still advantageous is that the second scheduler is a second instance of the first scheduler, and definition files of the first scheduler are copied for the second scheduler. In this way, the scheduling environments of the second scheduler agree with the productive first scheduler, and the second scheduler can be implemented with minimal expenditure.

Preferably, the second scheduler has a temporary scheduling system environment, which comprises the copied definition files as well as further parameters, and the test device is configured to expand the second scheduler with its scheduling environment at the beginning of a situation and to suppress it after its termination. An independent temporary scheduling system environment is established, used for the simulation of the JCL and subsequently deleted again, whereupon the simulated JCL can be verified. The test is therewith simple to implement and at the same time completely disappears from the productive system immediately after completion. In a preferred embodiment, the data processing facility is an IBM mainframe computer, the first and second schedulers are TWS systems and the control language for batch processing is JCL. As described above, this is a fundamental and frequently used architecture, especially in connection with large systems for which simulation is particularly important and which, at the same time, are also especially susceptible to the performance problem of conventional testing possibilities solved with the invention due to their extent.

Advantageously an entry in a subsystem table as well as a started task table of the operating system of the IBM mainframe computer is undertaken in this connection for the second scheduler. TWS z/OS, for example, needs as a system precondition an entry in the subsystem table as well as in the started task table of the operating system.

Advantageously, for the second scheduler the entries are made in the security system of the operating system of the IBM mainframe computer. TWS z/OZ, for example, offers interfaces to the security system of the operating system as a security concept option.

In a particularly preferred embodiment, a sorting unit is provided, which is constructed to receive a list of all work processes of the batch processing step at the beginning of the simulation and to sort them according to their execution times. Verification in the correct temporal sequence is therewith possible.

Advantageously the test device holds a list of all current files of the system ready, supplemented by files created, deleted, altered or read in work processes of the batch processing operation. Important information is provided for verification in such a file catalog.

In an advantageous further development, a testing unit is provided, which is designed to verify, for those work processes which provide for data access, whether a file to be created in accordance with the execution sequence ascertained by sorting is already created or whether a required file is not present, and if relevant to issue a warning notice. As a result, awareness of valuable error information can be created, since a job can of course not operate error-free if it does not find or leave behind the expected file structure.

Corresponding further developments of the method of the invention, as they are indicated in the dependent claims, have equivalent advantages.

The invention will be explained in more detail hereinafter, also with respect to further features and advantages, on the basis of an embodiment and with reference to the appended drawings, wherein:

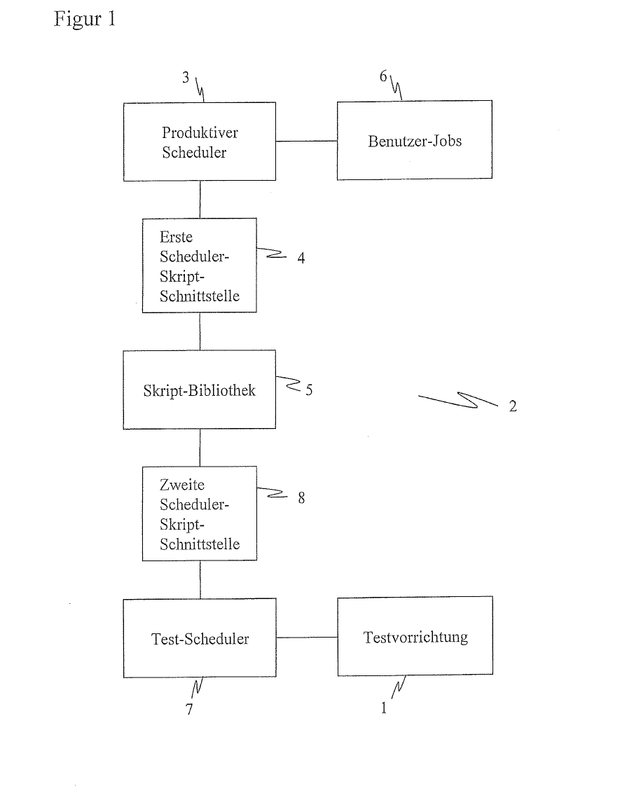

FIG. 1 Illustrates an arrangement of the invention of a test device in a data processing facility with scheduler system and

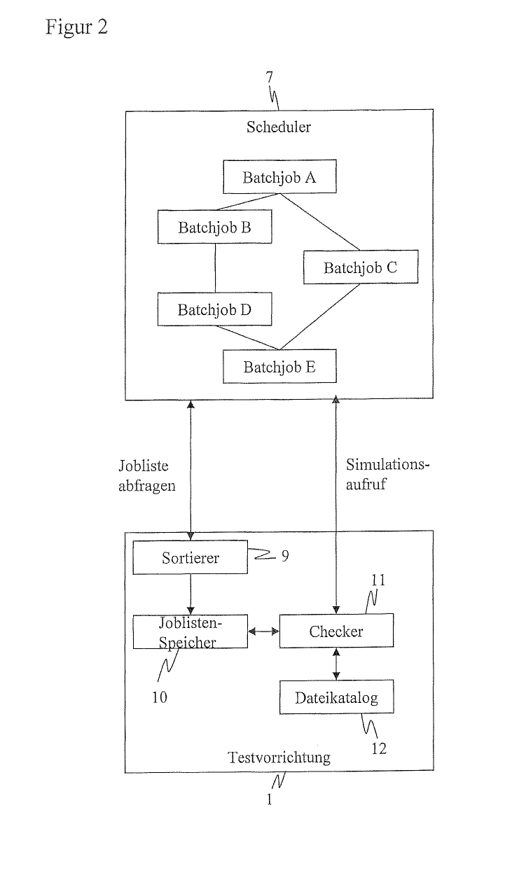

FIG. 2 Illustrates a detail view in accordance with FIG. 1 to explain the dependencies of jobs and the necessary communication between test device and scheduling system.

FIG. 1 illustrates an arrangement in accordance with the invention of a test device 1 in a data processing facility 2 with a productive first scheduler 3. The first scheduler accesses a script library 5 via a first scheduler script interface 4 in order to execute the jobs of a batch processing operation to be planned and controlled. At the same time, the first scheduler 3 receives user jobs 6, which are requested by users, for example, via a conventional user interface. A reason for this can be the maintenance and generation of job scripts in the script library 5, but it can also simply relate to the execution of one task independent of the maintenance of the scheduler 3. The field of application of the tasks which are executed by executing a script is very broad and relates to subordinate units. This could, for example, be the regulation of production processes in subordinate units. This, for example, could be the regulation of production processes in subordinate units. An illustrative example would be the control of a robotic line or filling in components corresponding to a recipe. In addition, natural internal sequences can be affected, perhaps a job which the JCL check itself starts.

In order that the performance of the productive first scheduler 1 does not suffer, a second test scheduler 7 is provided, which accesses the script library 5 via its own second scheduler script interface 8. It is therewith effectively prevented that bottlenecks arise in the first scheduler 3 or the interface 4 thereof when the test device 1 starts a mass simulation to verify the batch processing operation.

In FIG. 2, the communication between the test device 1 and scheduler 7 is illustrated once again in more detail to explain the dependencies of jobs and the necessary communication between the test device and scheduling system.

Batch jobs A-E, which must be planned by the scheduler systems, have numerous dependencies as is indicated by the graph structure in the figure. Such a dependency can be internal, for example because batch job B is dependent on a computing result from batch job A or batch job C generates an important file for batch job E. However, it can also simple be a necessary temporal sequence because, for example, a recipe specifies in which sequence additions are to be processed.

The test device 1 is advantageously configured to verify such dependencies in particular in relation to files. For this, the queried job list, which is usually returned by the scheduling system in a random sequence, is first temporally sorted in a sorter 9 and this job list is then filed in a job list memory 10. A real check unit 11 notes for each simulated job which files are affected, which is to say created, deleted, read or altered. The checker 11 keeps record in a connected file catalog memory 12 about these files, including their respective status. Consequently, the checker is in a position to recognize when a job is called up whether the file structure expected from the job exists, and it issues a warning if, for example, a job tries to read from a non-existing file or another job creates a file which already exists. This increases the effectiveness of the verification considerably, since such errors can impair the entire dependency chain of the batch job. Hence an erroneous deletion of a file X by batch job A in FIG. 2 would lead to errors in batch jobs B, D and E if one of the tasks of batch job B is to prepare the existing file X for batch jobs D and E. This will fail if file X does not exist at all.

The invention will now be explained once again in detail on the basis of the especially important IBM mainframe system. This description, however, should be understood as explanatory and not as restrictive since the invention just described does not depend on the computer environment. Likewise the product SmartJCL by HORIZONT is used as a job checker although the invention can also be used with other job checkers.

During the installation of SmartJCL, all relevant data on the type of the scheduling system, version number of the scheduling system, systems environment of the scheduling system as well as, for example, file names and the like are queried and stored inside SmartJCL.

For mass simulation, SmartJCL sets up an independent temporary scheduling system environment in which all files necessary for the temporary scheduling system are created with their own file names.

Subsequently, the definition files of the productive scheduling system are copied into the temporary scheduling system. In addition, some parameters of the parameter files of the productive scheduling system are copied into the temporary scheduling system. Other parameters are set with fixed values in the temporary scheduling system.

Then the temporary scheduling system is started by SmartJCL. A few seconds after the system start, the temporary scheduling system is available as an independent subsystem. Subsequently the daily schedule files for the temporary scheduling system are generated at a defined point in time on the basis of the definition files of the temporary scheduling system with the independent sequences of the scheduling system which SmartJCL dynamically generates. Now, the temporary scheduling system knows which jobs are to be executed at which time. SmartJCL reads out the daily schedule file of the temporary scheduling system and receives a list of all relevant jobs, among other things with the indication of the planned start time. Then, a simulation with each job of the list takes place. SmartJCL accesses the internal simulation function of the TWS z/OS scheduling system and receives the simulated JCL back.

Since no production is run with the temporary scheduling system, no users and no productive scheduling system are negatively impaired in this way. The system consumption negligibly increased by the temporary scheduling system on the same hardware plays no essential role for the overall performance.

Subsequently the simulated JCL can be verified and the JCL checker can perform its normal [services].

If several productive hardware or scheduling environments exist, then grouping can optionally take place according to the individual environments and simulated and verified individually for each environment. This takes place through corresponding selection parameters. In advantageous further development of the invention, the planned starting sequence of jobs is additionally verified though a catalog function, which keeps record of the files. The job checker can thus simulate and verify the data base processing (data flow) over many jobs.

For this, below code snippets of two jobs JOB1 and JOB2 are shown, wherein JOB1 generates a file coded with the compilation date of Feb. 28, 2005 in the file name, which is read by JOB2:

//JOB1 JOB (12345), MSGCLASS=X
//STEP1 EXEC PGM=XYZ, PARM= (A1, B2, C3)
//DD1 DD DSN=D050228.CD.EFGH, DISP=(NEW, CATLG)

JOB1 compiles the file D050228.CD.EFGN from the indication DISP=(NEW,CATLG).

//JOB2 JOB (12345), MSGCLASS=X
//STEP1 EXEC PGM=XYZ2, PARM= (A1, B2, C3)
//DD1 DD DSN=D050228.CD.EFGH, DISP=OLD

JOB2 reads this file from the indication of DISP=OLD. In the normal case JOB1 should run prior to JOB2 for this reason. The catalog function keeps record of the fate of the file D050228.CD.EFGH, which is to say that it is generated by JOB1 and is read by JOB2.

If the file, for example, already exists at the start of JOB1, the job will end with an error message. Likewise JOB2 will abort if the file does not exist. For this reason, an advantageous further function of SmartJCL is also to simulate the data file processing or administration and point out possible error sources of this type.

For this purpose the jobs of the daily schedule are sorted according to the job running sequence to be expected. For this, the planned job starting time of the job list can be used as well as the dependencies between the jobs on the basis of the data definition file or those of the daily schedule.

The jobs are now simulated exactly in the sequence of the job running sequence to be expected. Prior to the simulation of the first job, in addition the list of all files is read from the system catalog, that is, SmartJCL creates for itself an internal list with all files of the system through the catalog function.

SmartJCL thus simulates the data processing operation in that it verifies whether the file to be read/processed exists at the desired time, or whether a file can be created at the desired time (the file for this hence may not already exist). Files which are deleted in the jobs and/or newly created are correspondingly reprocessed in the internal file list.

Finally, it should once again be pointed out that reference is indeed always made above to SmartJCL as a specific JCL checker, but the invention can likewise be implemented in connection with other checkers.

1. A test device (1, 7, 8) for the verification of a batch processing operation in a data processing facility (2) with a first scheduler (3) for controlling the batch processing operation, the first scheduler (3) being configured to execute scripts from a script library (5) via a first script interface (4) in order consequently to execute or control work processes of subordinate units of an operation, characterized by a second scheduler (7), which is designed to simulate the execution of scripts from the script library (5) via a second script interface (8) which is independent of the first script interface (3), and to return result data of the simulation to an evaluation unit (1) of the test device (1, 7, 8).

2. The test device (1, 7, 8) according to claim 1, wherein the second scheduler (7) with the second script interface (8) is part of the data processing facility (2).

3. The test device (1, 7, 8) according to claim 1 or 2, wherein the second scheduler (7) is a second instance of the first scheduler (3) and definition files of the first scheduler (3) are copied for the second scheduler (7).

4. The test device (1, 7, 8) according to claim 3, wherein the second scheduler (7) has a temporary scheduling system environment, which comprises the copied definition files as well as further parameters, and wherein a control unit (1) of the test device (1, 7, 8) is configured to set up the second scheduler (7) up with its scheduling system environment at the beginning of a simulation and to remove it upon completion.

5. A test device (1, 7, 8) according to any one of claims 1 to 4, wherein the data processing facility (2) is an IBM mainframe computer, the first (3) and second schedulers (7) are TWS systems and the control language for batch processing is JCL.

6. The test device (1, 7, 8) according to claim 5, wherein an entry in a subsystem table of the operating system of the IBM mainframe computer is performed for the second scheduler (7).

7. A test device (1, 7, 8) according to any one of claims 1 to 6, wherein a sorting unit (9) is provided, which is designed to receive a list of all work processes of the batch processing operation to be executed at the beginning of the simulation and to sort according them to their execution times.

8. A test device (1, 7, 8) according to any one of claims 1 to 7, wherein the test device (10) holds a list of all data files created, deleted, altered or read by the work processes of the batch processing operation.

9. A test device (1, 7, 8) according to claims 7 and 8, wherein a verification unit (11) is provided, which is designed to verify for those work processes which provide data file access whether a file to be created in accordance with the execution sequence ascertained by sorting is already created or whether a required file does not exist, and if relevant to issue a warning notice.

10. A test method for verifying a batch processing operation in a data processing facility (2) with a first scheduler (3) for controlling batch processing, the first scheduler (3) being able to execute scripts from a script library (5) via a first script interface (4) in order to consequently execute or control work processes of subordinate units of an operation, characterized in that a second scheduler (7) simulates the execution of scripts from the script library (5) via a second script interface (8) independent of the first script interface (4) and makes result data of the simulation available for further evaluation.

11. The test method according to claim 10, wherein the entire test method runs on the same data base facility (2).

12. The test method according to claim 10 or 11, wherein the second scheduler (7) is a second instance of the first scheduler (3) and definition files of the first scheduler (3) are copied [for] the second scheduler (7).

13. The test method according to claim 12, wherein a temporary scheduling system environment is created for the second scheduler (7), which includes the definition files as well as further parameters, and wherein the second scheduler (7) with its scheduling system environment is set up at the beginning of a simulation and removed again upon completion.

14. A test method according to any one of claims 10 to 13, wherein the data processing facility (2) is an IBM mainframe computer, the first (3) and the second schedulers (7) are TWS systems and the control language for batch processing is JCL.

15. The test method according to claim 14, wherein an entry in a subsystem table of the operating system of the IBM mainframe computer (2) is performed for the second scheduler (7).

16. A test method according to any one of claims 10 to 15, wherein a list of all work processes of the batch processing operation to be conducted is received at the beginning of the simulation and sorted according to their execution times.

17. A test method according to any one of claims 10 to 16, wherein a list of all files created, deleted, altered or deleted by work processes of the batch processing operation is kept.

18. A test method according to claims 16 and 17, wherein for those work processes, which provide file access, it is verified whether a file to be created in accordance with the execution sequence ascertained by sorting is already created or whether a required file does not exist, and wherein if relevant a warning note is issued.
